(19) United States
(12) Patent Application Publication
(10) Pub. No.: US 2014/0373046 A1
(43) Pub. Date: Dec. 18, 2014

(54) Programming Filter

(71) Applicant: Tal Franji, Hod HaSharon (IL)

(72) Inventor: Tal Franji, Hod HaSharon (IL)

(73) Assignee: Google Inc.

(21) Appl. No.: 13/111,918

(22) Filed: May 19, 2011

Related U.S. Application Data
(60) Provisional application No. 61/346,343, filed on May 19, 2010.

(51) Int. Cl. H04N 7/025

(52) U.S. Cl. 725/34

(57) ABSTRACT

A computer-implemented method for providing electronic content to an individual includes receiving an indication that a user of a television controller intends to change away from viewing a video-based media program currently playing on a television controlled by the television controller; causing, with the television or the television controller, a user profile to be accessed that indicates preferences of the user related to video-based media program content, and to identify a media program that is currently accessible to the television and that is determined to match the user profile; and causing the television to display information about the identified media program.

### CROSS-REFERENCE TO RELATED APPLICATION

This application claims priority to U.S. Provisional Application Ser. No. 61/346,343, filed on May 19, 2010, entitled “Programming Filter,” the entire contents of which are hereby incorporated by reference.

### TECHNICAL FIELD

This disclosure relates to broadcast entertainment, and more particularly to providing targeted programming to a user.

### BACKGROUND

Between television, radio, and other media, consumers have a myriad of entertainment options from which to choose. In some cases, the options are dependent on location, and some places provide more programming options than do others. The channels that are available to a particular television viewer, for example, can depend on the location of the viewer and the type of television communications platforms in the viewer's area. In rural settings, a viewer can be limited to satellite transmissions or over-the-air broadcasts, since it can be cost prohibitive to install cable wire to remote locations. The opposite scenario often exists in heavily populated areas: consumers can be inundated with programming packages offering hundreds, if not thousands of programming channels. In some cases, such as those in which a viewer subscribes to a service such as cable or satellite programming, the viewer can choose from multiple programming packages to receive select channels or groups of channels. Viewers can be offered the ability to view “premium” channels that often come with an additional cost. Examples of premium channels can include broadcasts from network providers such as Home Box Office (HBO), or Pay-per-View (PPV).

### SUMMARY

A programming filter may, in certain embodiments, provide a user with personalized programming content. In selected embodiments, the programming filter comprises a user profile that indicates the user's programming preferences.

In one implementation, a computer-implemented method for providing electronic content to an individual is disclosed. The method comprises receiving an indication that a user of a television controller intends to change away from viewing a video-based media program currently playing on a television controlled by the television controller; causing, with the television or the television controller, a user profile to be accessed that indicates preferences of the user related to video-based media program content, and to identify a media program that is currently accessible to the television and that is determined to match the user profile; and causing the television to display information about the identified media program. The indication can be received by the user pressing a master button that is assigned to selecting programs or channels that are not identified by the user when the user presses the master button. The method can also include receiving repeated selections of the master button by the user, and in response, causing media programs to be displayed to the user that are selected based on past determined media preferences of the user. In certain aspects, successive selections of the master button result in nonconsecutive changes in television channels being displayed on the television. In yet other aspects, the television controller identifies a channel on which the media program is airing or about to air, and transmits to the television data that encodes the channel number. The television controller can also store data for the user profile, and identify the media program after obtaining electronic program guide information from a central server system that is remote from the television controller. Moreover, the television controller can comprise a consumer communication device onto which a user of the television remote controller has loaded a television remote control application, and causing the television to display information about the identified media program can comprise causing the television to automatically change to the identified media program, or causing the television to display information about the identified media program, wherein the information about the identified media program, if selected by the user, will cause the television to change to the identified media program. The method can also include identifying a length of time that the media program is displayed on the television and causing the user profile to be updated to reflect user preferences indicated by the length of time that the media program is displayed on the television.

In another implementation, a computer-implemented system for providing targeted television programming content is disclosed. The system comprises a television controller having a master channel changing button and circuitry to generate signals for controlling a television in range of the television controller; a program information repository storing information that identifies characteristics of video programs that are accessible by the television; a user profile that indicates preferences of a user of the television controller, the preferences based on prior user activity with respect to media content determined by the system; and a program selector programmed to compare information from the user profile to information about programs determined to be currently available to the user, in order to identify a channel to be automatically suggested to the user in response to selection of a single button on the television controller.

Unless otherwise defined, all technical terms used herein have the same meaning as commonly understood by one of ordinary skill in the art to which this disclosure pertains. Although methods and materials similar or equivalent to those described herein can be used to practice the disclosed concepts, suitable methods and materials are described below. All publications, patent applications, patents, and other references mentioned herein are incorporated by reference in their entirety. In case of conflict, the present specification, including definitions, will control. In addition, the methods and examples are illustrative only and not intended to be limiting.

The details of one or more embodiments are set forth in the accompanying drawings and the description below. Other features, objects, and advantages will be apparent from the description and drawings, and from the claims.

### DESCRIPTION OF DRAWINGS

FIG. 1 is one embodiment of a system for providing a channel selection for a viewer.

FIG. 2 is a flow chart showing steps for providing a user a personalized list of programming content.

FIG. 3 is a flow chart that illustrates a process for monitoring a user's viewing behavior.

FIG. 4 is a general description of a computing system, according to one embodiment, that can be used to carry out the methods disclosed herein.

Like reference symbols in the various drawings indicate like elements.

### DETAILED DESCRIPTION OF ILLUSTRATIVE EMBODIMENTS

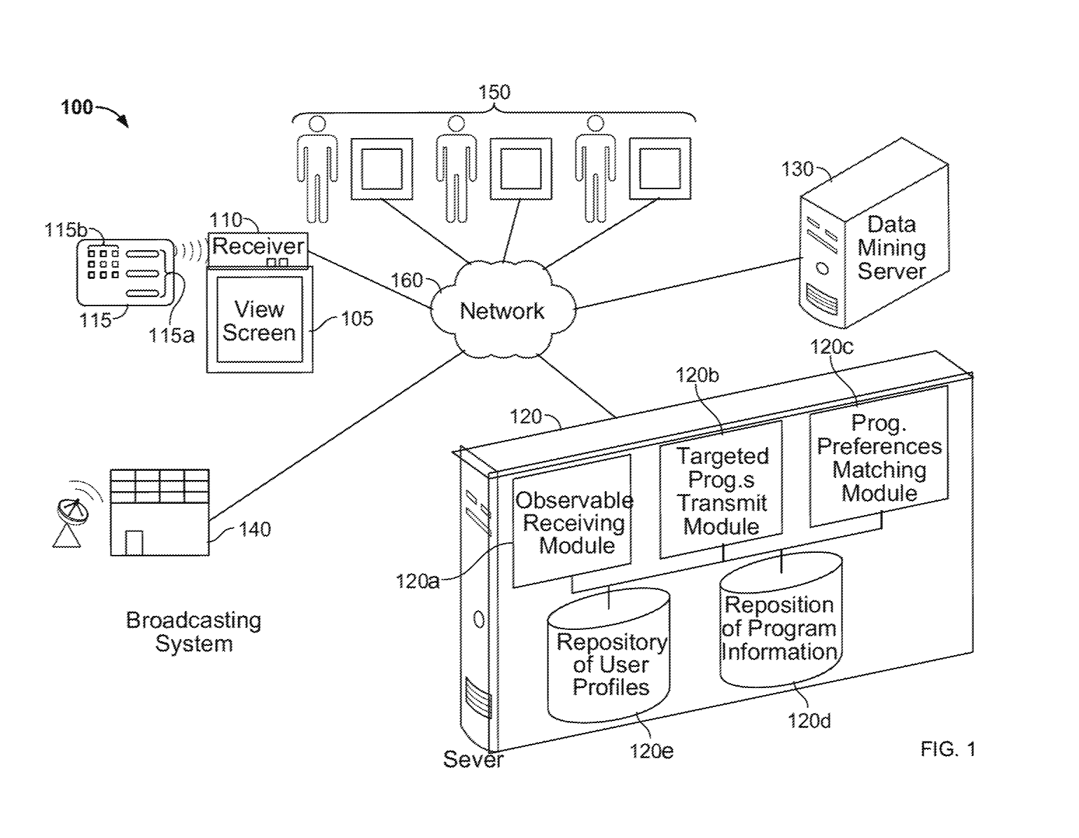

FIG. 1 is one embodiment of a system for providing a programming filter. In one general aspect, the system 100 can provide a user with personalized or targeted programming content according to the programming preferences of the user. In one embodiment, the system 100 can ascertain a user's programming preferences by monitoring the behaviors of the user when they are exposed to certain programs. Then, when a user requests a change in programming, such as, for example, changing the channel, the system can provide the user with a recommended program based on the user's programming preferences. In one general aspect, a user can simply press one “master” control button that changes a channel to the next program recommended by the system 100.

In one embodiment, a remote control 115 transceiver is provided that allows a user to send signal instructions to a receiver 110 that is in communication with a media device, such as viewscreen 105. In one example, the remote control 115 includes a “master” button 115a in addition to the standard buttons 115b commonly found on remote controls, such as integer buttons for entering a channel selection. The master button 115a can transmit a signal to receiver 110 and the receiver 110 can subsequently execute an instruction or instructions that correspond to the signal. In one embodiment, the instruction includes a request to change the channel that is currently displayed on the viewscreen 105. The system 100 can provide a preferred or recommended channel selected from a list of targeted programming content that is based on the user's learned programming preferences. Thus, when a user initiates a command to change the channel, the receiver 110 can automatically access the list of targeted programming content and tune into a recommended channel that is based on the user's programming preferences. In some embodiments, the list of targeted programming content can be digitally stored in the receiver 110 or stored remotely on a server 120. In some embodiments, programming content is provided by third-party computing systems, such as data mining servers 130 and broadcast systems 140.

In one embodiment, the system 100 can include a media display device such as a viewscreen 105. Viewscreen 105 can include electronic devices that can display images and produce sound, such as televisions, flat-screen displays, and projection systems. The viewscreen 105 can include inputs (not shown in FIG. 1) for receiving analog or digital sound and image signals from remote locations. In general, the viewscreen 105 can convert the remotely broadcast signals into images and display them to a viewer concurrently with any associated sound content. The viewscreen 105 can include the typical components of a modern digital television, including controls integrally adapted to control certain aspects of a broadcast. For example, sound volume, image contrast, brightness, color, and hue can be controlled by self-regulating mechanisms or by the viewer. The viewscreen 105 can also have integrated hardware and software that perform functions as a result of receiving input commands.

Receiver 110 can transmit broadcast signals to the viewscreen. Receiver 110 can include electronic devices that receive broadcasts from remote locations and send signals to the viewscreen 105 that allow display of the broadcast. In some embodiments the receiver can transmit broadcast signals to viewscreen 105 via an attached cable; in some embodiments the receiver can transmit broadcast signals to the viewscreen 105 wirelessly. Receiver 110 can also include hardware and software that can perform tasks related to accepting a user input, communicating with computers on a network, and communicating with the user. In a preferred embodiment, receiver 110 is a television receiver provided by a cable or satellite programming service, and can be separate form or integrated into a common housing with the viewscreen 105.

The remote control 115 can be used to communicate instructions and information to and from a receiver 110 and a user. The remote control 115 can include buttons, e.g., buttons 115b that, when depressed, send a signal including an instruction to the receiver 110. In some embodiments, the signal from the remote control 115 to the receiver 110 can be transmitted wirelessly; in other embodiments the connection is hardwired. The remote control 115 can include many or few buttons. In some embodiments, remote control 115 includes only a few select “master buttons” 115a, the operation of which are described below. In some embodiments, master buttons 115a are part of a larger set of buttons, including buttons 115b that could be found on, for example, commercially-available universal remote controls.

The remote control 115 can also identify a user. In some embodiments, the remote control 115 or the receiver 110 can identify a user. In some embodiments, the remote control 115 or the receiver 110 can store information pertaining to a user, such as storing a user profile within the device. Hardware for storing user profiles within the remote control 115 or the receiver 110 can include associated memory, such as random access memory (RAM), or read-only memory (ROM), or be stored on a computer-readable medium such as a hard-disk drive.

The user can also identify themselves to the remote control 115 or receiver 110 by entering a code. The code can distinguish one user from another, such that when a user enters their code, the profile of the user is retrieved, for example, from memory, or a user file, and that person's profile becomes the ‘active’ operational state of the device. In some embodiments, the user can be distinguished using biometric identification. In one example, a remote control 115 or receiver 100 can include a fingerprint scanner that is used to identify a particular user and distinguish them from other users. In practice, a user can swipe their finger across the scanner prior to using the device, thereby activating their profile.

User profiles can include information about the user, such as demographic information such as their age or age range, gender, marital status, and location. User profiles can also contain information about the programming preferences of the user. In some embodiments, the system 100 can determine a user's preferences by recording a behavior of a user when they are presented with a certain type of program. For example, the remote control 115 and/or the receiver 110 can record information relating to how much time a viewer spends at a particular channel while scrolling through available programming content. For example, a male viewer may instantly change the channel if he encounters programming content directed toward women, such as a particular talk show or a commercial for make-up products. Conversely, a male (or at least a stereotypical male) may spend more time watching a football game or a show about hunting. Related programming information, such as the channel, network, or program title can be recorded along with the time spent at each channel. Over time, the user's profile can, in part, be constructed of such behavioral information; as discussed below, the user's profile can be used to “learn” the user's programming preferences.

The system 100 can access external programming data provided by a data miner 130 during the process of seeking out programming content that matches a user's preferences, as described more fully below. Data miner 130 can be a computing system or service that tracks programming preferences of users, and provides audience composition (e.g., demographics) for programs. Non-limiting examples include program ratings provided by Nielson Media Research (i.e., the “Nielson ratings”). In some embodiments, the system 100 can use programming data provided by the broadcast source 140, such as an online programming guide. In other embodiments, the system 100 can collect programming information from third-party programming resources, including websites and other online content, for example, from TVGuide.com.

The receiver 110 in this example is in communication with server 120. The server 120 can be remote from the receiver 110, and communication can be accomplished via a network 160 of computing systems (e.g., including the Internet). Server 120 can also include computer hardware and software modules that can execute programs, store and retrieve data, and process input and output functions relating to providing a user with a programming selection.

In one general aspect, server 120 includes software modules and repositories (e.g., digital storage) that can be used to execute instructions and store user profile data, respectively. In one embodiment, server 120 can include an observable receiver module 120a. Observables can include recordings of user behaviors in response to particular programming content and are described more fully below. The receiver module 120a can perform computing processes relating to accepting a request from a remote client computing system, such as receiver 110 for targeted programming content. In one embodiment, receiver module 120a can check access permissions related to the user. The receiving module 120a, in general, can be considered the gateway into the server 120; requests for targeted programming content can be received and information can be parsed from the incoming request by the module 120a and passed along to other modules and repositories.

The server 120 can include a targeted programming content transmitting module 120b. The module 120b can carry out functions that relate to sending a list of programs that align with the user's programming preferences, the process of which is discussed below. In some embodiments, the module 120b can transmit data from the server to a remote client computing system (such as receiver 110), a remote computer, or a remote control (such as remote control 115). The module 120b can perform the necessary translations between computing languages or formats necessary for the remote client computing system to recognize and integrate the data into its operating system. In some embodiments, a universally-accepted programming language can be used to exchange data between the remote client computing system and the server 120. Examples of such programming languages include HTML, XML, and Java.

In one general aspect, a programming preferences matching module 120c can perform matching calculations to provide a list of program content that correlates with the programming preferences of a user. The matching module 120c can perform functions, given certain input, to arrive at a calculated value that ranks the potential likelihood that a user will enjoy a particular program, based on values defined in a user profile. In one embodiment, the user's profile can include data corresponding to likes and dislikes of certain programming content. For example, a user's profile may indicate that a user is a big fan of action movies, yet has a particular distain for romance comedies. The matching module 120c can examine the user's preferences within the user profile and seek out programming content that contain or exhibit matching characteristics.

Such characteristics of available programming content can be accessed by public and private information regarding a particular program. For instance, many websites offering electronic programming guides (EPG's) provide programming calendars with information associated with each program. Some program information may include, for example, a genre, rating, and title of the show at a minimum. Other EPG's can provide extensive information up to and including the professional histories of each of the actors appearing in the program. The matching module 120c can perform computing functions to match a user's programming preferences with information available about a particular show or program series to arrive at a probability of match success.

Server 120, in certain examples, can include a repository of program information 120d that can store information relating to program content. The program repository 120d can store information gathered from third-party computing systems such as online EPG's and broadcasting systems 140. In addition, the program repository 120d can store information added by users of the system 100. In one embodiment, users can add supplemental information to stored program information. For example, to the programming information for the movie “Old School” (starring Will Farrell), a user could add “fans of Will Farrell may also enjoy the movie Talladega Nights.” The server 120 can store repository information in a format that allows for indexing and retrieval of pertinent information.

The server 120 can also include a repository of user profiles 120e. This repository 120e can contain information necessary to identify users and store user programming preferences. User profiles can include demographic information about the user as well as data relating to recorded observables, as discussed below. In some embodiments, a user's profile can be accessed by the user. In such embodiments, the user can modify and personalize their profile by a set of pre-defined standards, for example, or by indicating their preferences according to a set of criteria that exemplifies their programming taste(s). A user may be led by a series of progressively-narrowing questions (e.g., through a decision tree) about their programming preferences that allows certain criteria to be associated with the user.

The modules of the server can also inter-communicate so as to provide input and output channels to receive and send data to a user, respectively. In one exemplary embodiment of the operation of the system 100, a remote client computing system, e.g., receiver 110, can send a request for a targeted programming content list to the server 120 which request is received by the observable receiving module 120a. The user's profile can be retrieved from the repository of user profiles 120e, and any observables contained within the request can be appended to the user profile; the contents of the request from the remote client computing system and the user profile can be sent to the matching module 120c. The matching module 120c can perform, such as by a pre-defined matching algorithm, a matching analysis between the user's programming preferences and the program content information stored in the repository of program information 120d. A list of programming content, calculated and compiled by the matching module 120c, can be sent to the targeted program sending module 120b, which sends the list of programs, tailored to the user, back to the remote client computing system.

A selection (e.g., a particular program or channel) from the list of targeted programming content received by the remote client computing system can be accessed by the user by simply pressing one master button 115a. Pressing a master button 115a can, according to one embodiment, send a communication to the receiver 110 that instructs the receiver to change to one of the channels in the retrieved list of targeted programming content. In one embodiment, the user can scroll through a list of channels related to the targeted programming content by repeatedly pressing a master button 115a. In one embodiment, a channel can be selected for the user without the user necessarily viewing the contents of the programming content list provided by the server 120.

In addition, the system 100 can provide a user with targeted programming content in the absence of information that identifies the user explicitly. In one embodiment, an anonymous, yet unique identifier (ID) can be associated with a user. In one example, an anonymous ID is simply a string of alphanumeric characters. The anonymous ID can be generated from a concatenation of two identification sources, for example: one from a receiver, which may provide a base code, and one from a remote control that implicitly identifies the user. For example, a remote control 115 may have five “user” buttons on it (not shown in FIG. 1). Each button can be assigned to a member of a family, such that each time a family member uses the remote control (e.g., when they pick it up to use it), they press their assigned button. The assigned button can have a number or other identifier associated with it, such that when the remote control transmits an execution instruction, such as an instruction to change the channel, the identifying code is transmitted as well. A receiver (e.g., receiver 110) may have associated with it a base code assigned by, for example, a telecommunications company. In some embodiments, the code can provide information on the physical whereabouts of the receiver, such as a unique IP address. When the receiver transmits information to the server 120, as described above, the receiver can append the anonymous ID to the information. The server 120 can store the programming information and habits related to the anonymous ID. Over time, the habits of the user relating to their programming preferences can be learned and associated with the anonymous ID.

The user's programming preferences can be continually sampled and updated each time the user interacts with the system 100, thereby creating a constantly-evolving profile containing the user's programming likes and dislikes. In one embodiment, when a user is scrolling through a list of retrieved targeted programming content, the remote control 115 and/or the receiver 110 can monitor how long the user stays at a particular channel. If, for example, the user stays less than a pre-defined amount of time (say, 10 seconds) at a particular channel, this channel can be flagged as one that the user does not seem to enjoy, such that it will not be included on subsequent lists of targeted programming content. In one embodiment, a channel or program can be flagged as a positive or negative match to the user's preferences by modifying a file containing a list of targeted program content. Correspondingly, the system 100 may adapt the retrieval of future programming content based on this and similar behaviors.

When the system 100 provides a successful match between the user's programming preferences and a particular channel provided in the targeted programming content list, the system 100 can search for other similar channels or program content in an attempt to build an “ideal” list of channels or programming content for a user. For example, if the user spends a certain pre-defined amount of time watching the show “COPS” every time they encounter that particular television program, the system 100 can infer that the user enjoys reality shows involving public safety officials. Accordingly, the system 100 may seek out other related television programs, for example, “L.A.P.D.: Life on the Beat;” the system 100 may also investigate whether the user enjoys dramas about police by adding “CSI Miami” to the user's list of targeted programming content. In the absence of a negative indication in subsequent interactions with the system 100, the system 100 can infer that “CSI Miami” was a successful addition to the user's targeted programming list. In essence, the system 100 can continually learn a user's programming preferences by adding or removing channels to the targeted programming content list, and amend the list in future evolutions based on indications of whether or not the amendment was successful.

The system 100 can also use indications of a user's preferences other than how long a user remains with a particular program. In one embodiment, the behaviors of a user can be monitored when, for example, they are scrolling through a programming guide. In some cases, a user will select a program from a guide and retrieve additional information about the show prior to watching it. This can indicate, at a minimum, to the system 100 that the user has at least partial interest in the selected program. Whether or not the user changes channels to that particular program, or, for example, sets the receiver 110 to record the program, can provide additional indications of the user's programming preferences. Such interactions can be recorded by, for example, the receiver 110 and appended to the user's profile.

The system 100 can also suggest programs to a user based on a recognized pattern related to the user's behavior at certain times of the day. For example, a user may enjoy watching a particular type of programming during one time of the day, and another type of programming during another time of day. Take for example, a person who is an avid fan of the “X-Games” and its coverage on certain sports networks. When this person sits down to watch television, the system 100 may initially provide them with a channel broadcasting coverage of the X-games sporting events. However, it may be late at night, and the person may not wish to be subject to fast paced action with loud rock music that often accompanies this program. Instead, the person may wish to watch a talk show or news channel to lull them into a sleepy state of being. The system 100 may recognize that, while the user greatly enjoys high levels of visual and auditory stimulation during the day, at night the user generally wishes to view peaceful programming. Correspondingly, when the user sits down to watch television past a certain time of day (say, e.g., 10:00 PM), the system 100 may initially provide the user with peaceful programming, for example, a soft music channel, or a nature show.

In one general aspect, lists of targeted programming content can be segregated according to certain criteria, and the user can select a criteria prior to scrolling through the programming content. In one embodiment, the lists can be categorized by the type of programming they fall under. For example, a list of sports programs targeted to the user may be displayed under a heading “sports.” Similarly, categories may exist for “news,” “movies,” etc. In this embodiment, the user can first select a general class of programming they wish to watch. The targeted programming content selected by the system 100 in each category, then, can be accessed in the same way as has been described above for the more global aspect. In this aspect, the system 100 can keep track of individual lists in distinct categories, and, like the general aspects described above, the system 100 can learn the user's preferences based on their apparent like or dislike of certain programs.

The list of programming content constructed for a particular user by the system 100 can be ordered or ranked by a given criteria. For example, a list of targeted programs may be ordered in rank from “strongest match” to “weakest match” with regard to the calculated programming preferences of the user. In practice, when a user sits down to watch television, he or she can use a master button 115a to scroll through the list of programs, most preferably beginning with the “strongest match” and progressing to the “weakest match.”

The number of programs in a list of targeted programs can be selected by the user. For example, the user may wish to be presented with the top 100 most likely candidates for a match to their particular programming preferences. Similarly, a user can dictate the number of suggested programs listed in each of categories specified as above. For example, a user may wish to only display 10 of the top movie matches, but 50 of the top matches in a “drama” category.

Moreover, the programming content contained within a list of targeted programming content can include events that are currently being broadcast by a broadcasting system 140. For example, regularly-scheduled television events. In another general aspect of the system 100, the programming content contained within a list of targeted programming content can include pre-recorded programs. Non-limiting examples of pre-recorded programs can include programs that are essentially always available to the viewer, such as “On Demand” programs or Pay-Per-View events.

In yet other embodiments, a standard television that does not suggest programming in the manners discussed here can be paired with a remote control application or app running on a mobile computing device such as a smartphone. The app may generate standard remote control selections, such as for changing volume and channels on the television. The app may also display a “master” button like those discussed above, whose selection causes the television (or a set-top box that serves the television) to change to a channel that is targeted to interests of the user. For example, the app may contact a server like server 120 above and provide information that identifies the user's current head end. The server may then perform according to the techniques above to identify a channel number, and may send data that identifies that channel number to the remote control app on the mobile device. Alternatively, the app may track prior user activity itself and make the targeting decisions for programming discussed above.

The app may then cause the mobile device to send to the television a signal that identifies a particular channel that was determined by the app or the server 120 to be carrying a program that is of interest to the user who is currently logged in on the mobile device (where different users may log into the mobile device at different times under different accounts). In this manner, the functionality discussed above may be provided, in certain implementations, simply by loading an app on a user's smartphone, and can be used with existing television-related components that the user already owns.

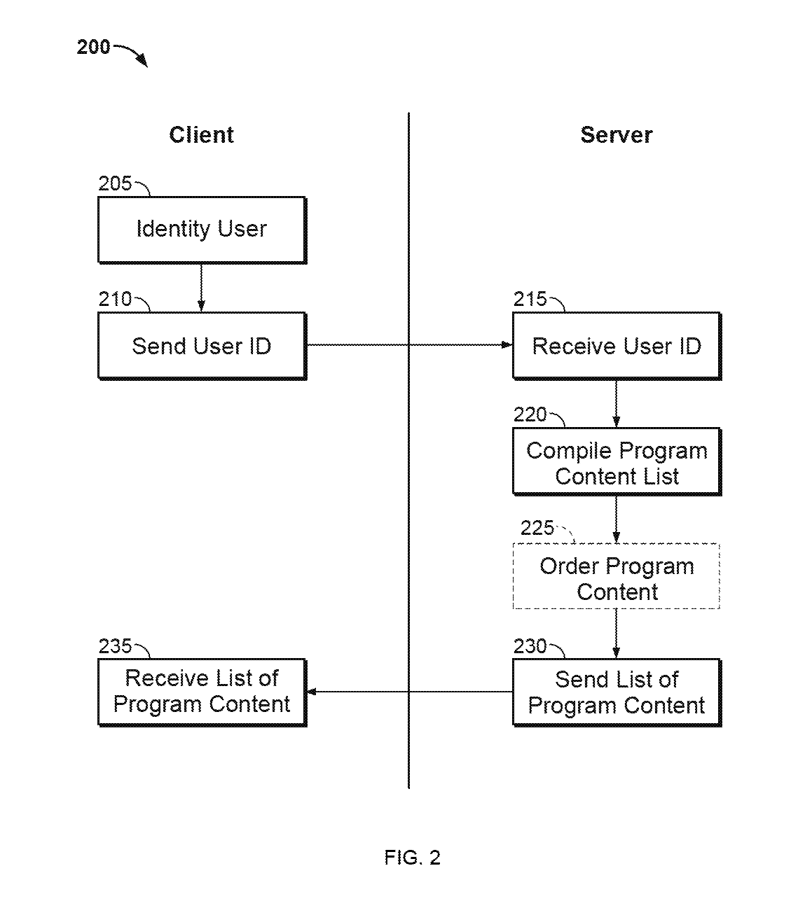

FIG. 2 is a flow chart 200 that, according to one general aspect, outlines some of the steps for providing a user a personalized list of programming content from which to choose. The flow chart 200 is broken into “client” and “server” portions to exemplify the communication of data between the two entities. “Client,” in the flow chart 200 can refer to a remote client computing system, such as, for example, a remote control (e.g., remote control 115) or a receiver (e.g., receiver 110).

Beginning at step 205, the client identifies the user. The identification process may occur by any of the methods described above, such as by biometric identification. Other methods of identifying a user are also possible, including, for example, providing separate buttons on a remote control or receiver (not shown in FIG. 1) that correspond to a particular user. When the user picks up the remote, for example, the user identifies themselves to the client by pressing their assigned button.

Next, at step 210, a unique identifier is sent to the server. The unique identifier can contain information about the user that can be lengthy, such as by including their demographic information, or it may be relatively short, to include only a user ID. In some embodiments, if behaviors have been recorded since the last time the client communicated with the server, the behaviors can be transmitted with the user ID.

At step 215, this information is received by the server. The server can analyze the information sent in step 210 for information that will be used to determine the viewing habits of the user. In some embodiments, a lengthy user profile can be sent to the server that specifically indicates the user's programming preferences, which can potentially result in a rapid collection of programming content that the user may find enjoyable. In other embodiments, the information may be sparse, leading to a more in-depth analysis required by the server to determine appropriate programming content lists. In some embodiments, a default list of programming content can be provided to the user the first time the user accesses the system 100, and the user profile subsequently evolves according to the methods described herein.

Next, at step 220, the programming content list is compiled by the server. In some embodiments, the server can retrieve pre-existing lists of programs corresponding to other users of the system 100 having similar programming preferences of the user. The system can use profile information to provide matches between users, such as by matching their demographic information, similarity in selected programs, among other criteria such as regional area of the user.

In some embodiments, the server can store profiles of each user. When a user accesses the system, they may immediately retrieve a programming content list provided just for them which has been updated since the last time they logged in. For example, the system can dynamically update a user's programming content list based on the viewing habits of users with similar profiles even when the user is not logged in to the system. In this manner, the user's programming content list can be kept current of the most popular programs within a certain demographic, for example.

Each program can also be associated with a particular channel where that program may be viewed, and can be included as part of the compiled list of programming content. In some embodiments, the user may never actually see these channel listings, as, in some embodiments, it is irrelevant to the user. The user can simply press a master button which can change the displayed program; the channel can be switched appropriately by the receiver without guidance or input by the user.

Optional step 225 can include listing the programming content list in a particular order as described above. In some cases, the list can simply include the most likely matches for a user's programming preference ranked from most to least likely. In other cases, the list may be categorized into sub-lists as described above.

Next, at step 230, the compiled list of programming content is sent to the client. The list can contain all the information necessary such that when a user presses a master control button (e.g., button 115a), a program from the list is selected for the user, and the receiver tunes in to the correct channel to display the program.

At step 235, the client receives the list of program content. In some embodiments, the client can store the program content list in such a way that it is integral with the operation of the receiver or remote control. For example, the receiver or remote control may use software or hardware commands to effect channel changing or to display content to the user. The programming content list can similarly be stored in a format that allows interactivity between the list and the associated hardware and/or software of the media device.

In one general aspect, information about the user's viewing habits and preferences can be recorded in real time as it is collected. In one embodiment, a user's viewing habits and preferences are continually updated in the user's profile.

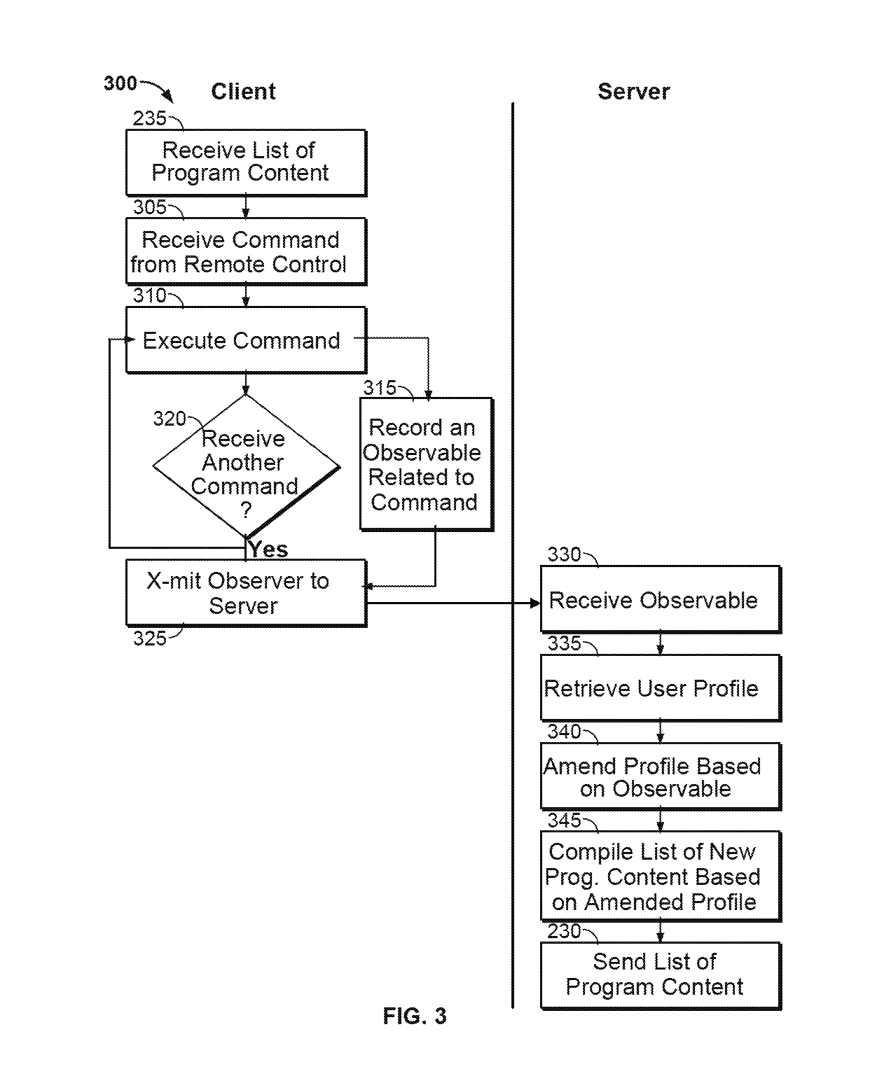

FIG. 3 is a flow chart 300 that illustrates some of the steps for monitoring a user's viewing behaviors relating to displayed program content, according to one embodiment. The beginning of flow chart 300 provides that a client system (such as a receiver or remote control) has received a list of targeted programming content (e.g., step 235 from FIG. 2) and that the user is receiving programming from at least one of the selected programming events. At step 305, the client system receives a command to perform an action. The command may be to change the channel currently being watched, for example, and may originate from a remote control or by the user entering commands directly into a receiver.

Next, at step 310, the client system executes the command. As discussed above, the client system may access a list of targeted programming events that the system 100 has determined may be enjoyable to the user. The list of targeted programming events may have an associated channel or frequency to tune to, to access the particular programming event. The client system, in executing the command, may reference the list of targeted programming events to determine which event should be tuned to next. For example, the client system may simply retrieve the next program on the list and tune to that channel. In some embodiments, the user can initiate a command to access a certain type of programming, for example, a sporting event, and the command may include accessing that particular list of events and selecting the first program on the list. The client system can then switch to the appropriate channel.

Step 315 provides that concurrent with the command execution, the client can begin the process of recording an observable related to the command. An observable can be something that can be measured or observed directly, such as the length of time the user stays on a channel. In one embodiment, the client system begins a timer to measure how long a viewer stays on a particular channel after the client system tunes to that channel. Observables can provide indications as to the preferences of the viewer. For example, consider a situation where system 100 has included “Oprah” as a programming event for a male viewer (perhaps the subject of the show relates to ‘gifts women want for Christmas’), and the male viewer is presented with this program upon changing the channel. If the viewer immediately (or say, within 5 seconds, for example) changes the channel, the client system can log this observable in a database or append this observable to the targeted list of programming events, indicating this program was a poor choice for the particular viewer.

The system 100 can continue to monitor observables until the client system receives another command, step 320, at which point the process can restart at step 310. Step 325 provides a phase where the observables can be transmitted to the server. Step 325 can be considered the “feedback” mechanism to the server that indicates whether the programs selected for the particular user were chosen accurately or whether some adjustment in the user's perceived programming preferences needs modification. In one embodiment, the list of targeted programming events can be transmitted to the server along with any observable information recorded by the client system appended thereto. In another embodiment, the client system can construct a list that is transmittable in electronic format that contains programs or genres which do or do not seem to agree with the user's programming preferences based on the observables. The list can be used by the server to determine likely successful matches for future programming selections. Step 325 may occur substantially synchronously with step 310 (i.e., after another command has been received by the client system), or, it may occur at selected times. In the latter embodiment, the user may select a certain time of day for the client system to transmit the information it collects to the server system.

Next, at step 330, the server receives the information sent by the client system. During this step the server can decipher the user based on identifiable information contained within, for example, a header section that lists a user ID as discussed above.

At step 335, the user's profile is retrieved. The user's profile may be stored locally on the server or remotely on a separate computing system. Retrieval of the user's profile includes opening the file and making it accessible to read/write instructions by the server.

Next, at step 340, the user's profile is amended based on the observable information. In one embodiment, the observable information can be added directly into the user's profile, such as including a list of shows that the user routinely shows disinterest in, which can be measured, for example, by the amount of time the user views that particular program. In another embodiment, the server can use the information defined by the program observables to correlate the viewer's likes and dislikes according to particular aspects of programs. For example, if a user routinely (or repetitively) skips past sporting events chosen for him in a previous list of programming events, the server can recognize that the user is not a sports fan. Similarly, if the observables indicate that the viewer spends a great deal of time watching programs that star a particular actor or actress, the viewer's profile may correspondingly be made to reflect this preference so that future targeted programming lists can include more programs with their favorite actors.

Next, at step 345, a new list of targeted programming content can be compiled based on the newly-amended information from step 340. In preferred embodiments, the observable information is archived in the user's profile. During a search for targeted programming content, the server can access the archived information and use this in the determination for what would be a likely match to the viewer's programming preferences.

The process outlined in FIG. 3 can be viewed as a constantly-evolving programming filter, where only those programs that have been selected by the system 100 as potential matches to the viewer's programming preferences are allowed through to the viewer (ones that match the viewer's preferences), and a great many of the vast array of programming choices available to the consumer are filtered out (those that do not correspond with the viewer's preferences).

In one general aspect, a user's programming preferences profile can be made available to the user for them to adjust or modify. This aspect can be useful to quickly establish a set of “ground rules” on which the system 100 can base calculations as to what the user's perceived preferences relate to. For example, a user can indicate that they enjoy certain types of television shows (e.g., daytime talk shows or documentaries), genres (e.g., comedies), or seeing particular actors. From this relatively minimal set of criteria, the system 100 can begin to establish a user profile based on these and other data collected by the system 100 as discussed above.

In one embodiment, a user can make their profile available to another user. For example, two friends may share very similar tastes in action movies. The friends can make their profiles available to each other, and, relatedly, the system 100 can be programmed to indicate that when a modification is made to one profile (e.g., through the filtering process described above), the same modification should be made to the other. In some embodiments, user profiles can be made “public” and those with similar profiles can enjoy the benefit of the experiences of their “peers” with respect to generating a list of highly targeted programs to enjoy.

Some programs on a user's list of targeted program content may not be airing at a time when the user attempts to access the program. In this situation, one alternative action is that the client system, e.g., the television receiver, can simply proceed to a subsequent listed program. In another embodiment, the client system can request the program from a source that has the program stored. On Demand and other similar services, plus “premium” services (HBO, Cinemax, etc.) can provide this functionality.

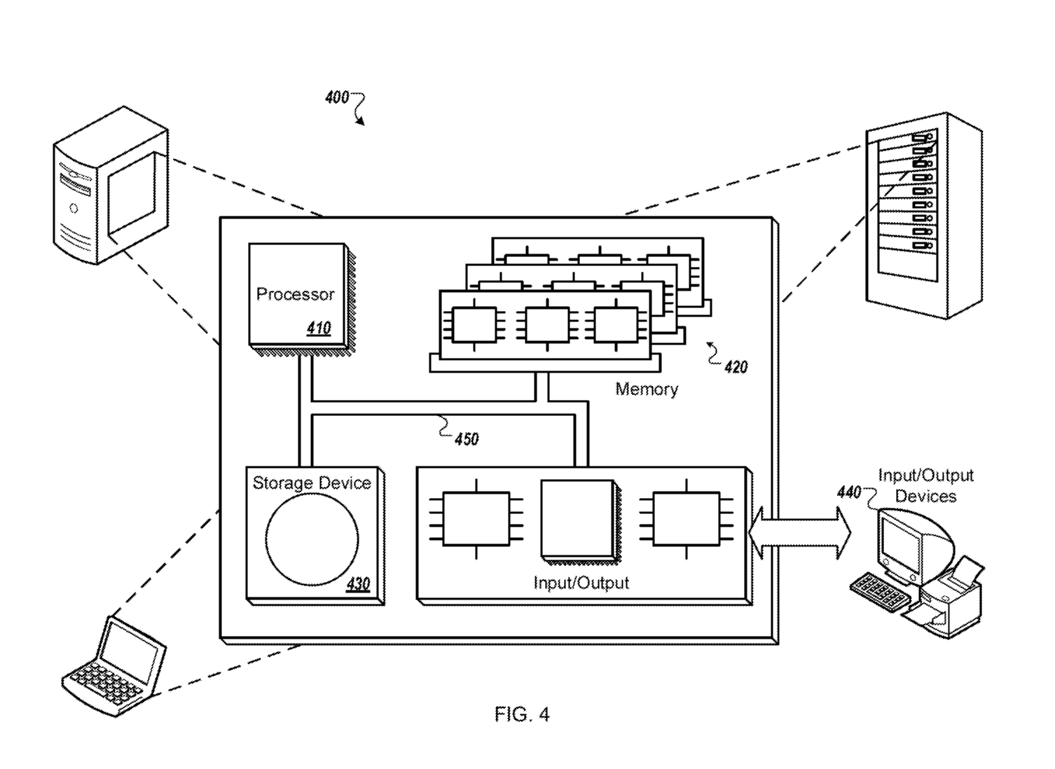

FIG. 4 is a block diagram of computing devices 400 that may be used to implement the systems and methods described in this document, either as a client, as a server, or as a plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, memory on processor 402, or a propagated signal.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communication audibly using audio codec 460, which may receive spoken information from a user and convert it to usable digital information. Audio codex 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smart phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. For example, receiver 110 and viewscreen 105 may exist as one, integrated device instead of two separate devices as illustrated in FIG. 1. Accordingly, other embodiments are within the scope of the following claims.

1. A computer-implemented method, comprising:
receiving an indication that a user of a television controller has selected a control to change, immediately upon selection of the control, to an unidentified media program and away from viewing a video-based media program that is currently playing on a television controlled by the television controller when the control is selected, wherein the control is assigned to causing, in response to selection of the control, the television or the television controller to automatically identify and immediately change to programs or channels that are not identified by the user, and that have not been identified by the user when the user selects the control;
causing, with the television or the television controller, a user account to be accessed that indicates preferences related to video-based media program content, and to automatically identify a media program that is currently accessible to the television and that is determined to match the preferences from the user account; and
causing, in response to receiving the indication that the user has selected the control, the television to immediately change upon selection of the control to the identified media program without the user selecting or otherwise identifying the identified media program, and without the user having selected or otherwise having identified the automatically identified media program.

2. (canceled)

3. The method of claim 1, further comprising receiving repeated selections of the control by the user, and in response, causing media programs to be displayed to the user that are selected based on past determined media preferences of the user.

4. The method of claim 3, wherein successive selections of the control cause television channels to be displayed non-consecutively on the television.

5. The method of claim 1, wherein the television controller identifies a channel on which the identified media program is airing or is about to air, and in response, transmits to the television data that encodes a channel number for the identified channel on which the identified media program is airing or is about to air.

6. The method of claim 1, wherein the television controller stores data associated with the user account, and identifies the media program using the stored data that is associated with the user account and electronic program guide information that is obtained from a central server system that is remote from the television controller.

7. The method of claim 1, wherein the television controller comprises a consumer communication device onto which a user of the television controller has loaded a television remote control application.

8. (canceled)

9. The method of claim 1, further comprising identifying a length of time that the identified media program is displayed on the television and causing the user profile to be updated to reflect user preferences indicated by the length of time that the identified media program is displayed on the television.

10. One or more tangible, non-transitory computer-readable media having stored there on instructions that, when executed by one or more computer processors, cause operations to be performed that comprise:
receiving an indication that a user of a television controller has selected a control to change, immediately upon selection of the control, to an unidentified media program and away from viewing a video-based media program that is currently playing on a television controlled by the television controller when the control is selected, wherein the control is assigned to causing, in response to selection of the control, the television or the television controller to automatically identify and immediately change to programs or channels that are not identified by the user, and that have not been identified by the user when the user selects the control;
causing, with the television or the television controller, a user account to be accessed that indicates preferences related to video-based media program content, and to automatically identify a media program that is currently accessible to the television and that is determined to match the preferences from the user account; and
causing, in response to receiving the indication that the user has selected the control, the television to immediately change upon selection of the control to the identified media program without the user selecting or otherwise identifying the identified media program, and without the user having selected or otherwise having identified the automatically identified media program.

11. (canceled)

12. The tangible, non-transitory computer-readable media of claim 10, wherein the operations further comprise receiving repeated selections of the control by the user, and in response, causing media programs to be displayed to the user that are selected based on past determined media preferences of the user.

13. The tangible, non-transitory computer-readable media of claim 12, wherein successive selections of the control cause television channels to be displayed non-consecutively on the television.

14. The tangible, non-transitory computer-readable media of claim 10, wherein the television controller identifies a channel on which the identified media program is airing or is about to air, and in response, transmits to the television data that encodes a channel number for the identified channel on which the identified media program is airing or is about to air.

15. (canceled)

16. The tangible, non-transitory computer-readable media of claim 10, wherein the operations further comprise identifying a length of time that the identified media program is displayed on the television and causing the user profile to be updated to reflect user preferences indicated by the length of time that the identified media program is displayed on the television.

17. A computer-implemented system for providing targeted television programming content, the system comprising:
a television controller having a master channel changing button and circuitry to generate signals for controlling a television in range of the television controller, the master channel changing button configured to generate a particular signal, in response to selection of the master channel changing button, that indicates that a user of the television controller intends to change, immediately upon selection of the master channel changing button, away from a video program currently playing on the television and to change to a recommended video program that is not identified, and that has not been identified, by the user when the user selects the master channel changing button;
a program information repository storing information that identifies characteristics of video programs that are accessible by the television;
a user account that indicates user preferences related to video programming content, the preferences based on prior user activity with respect to media content determined by the system;
a program selector that identifies a suggested video program by comparing information from the user account to information about programs determined to be currently available to the user;
and a channel changer that automatically causes, in response to receiving an indication that the user has selected the master channel changing button, the television to immediately change channels upon selection of the master channel changing button to the suggested video program without the user selecting or otherwise identifying the suggested video program, and without the user having selected or otherwise having identified the suggested media program.

18. The computer-implemented system of claim 17, wherein the system is programmed to identify preferences of the user based on amounts of time that the user spends viewing particular video programs, and based on characteristic of the video programs stored in the program information repository.

19. The computer-implemented system of claim 17, wherein the television controller is programmed to identify a channel on which the suggested video program is airing or is about to air, and transmits to the television data that encodes a channel number for the identified channel on which the suggested video program is airing or is about to air.

20. The method of claim 7, wherein the consumer communication device comprises a mobile computing device.

21. The method of claim 1, further comprising updating user profile information for the user within the user account to indicate the preferences of the user based on viewing habits of one or more other users that have similar profiles as the user.

22. The method of claim 1, further comprising identifying a particular user whose user profile is to be accessed from a group that includes the particular user and other users, the particular user and other users each having user profiles that indicate a preference of each user related to video-based media program content.

23. The method of claim 1, wherein the control comprises a master channel changing button on the television controller.
